(19) United States
(12) Patent Application Publication
(10) Pub. No.: US 2011/0183092 A1
(43) Pub. Date: Jul. 28, 2011

(54) Bedroll Protector

(76) Inventor: Tom Wandel, Ebensburg, PA (US)

(21) Appl. No.: 13/079,954

(22) Filed: Apr. 5, 2011

Related U.S. Application Data
(63) Continuation-in-part of application No. 11/861,463, filed on Sep. 26, 2007, now Pat. No. 7,506,806.

(51) Int. Cl. B32B 1/02

(52) U.S. Cl. 428/35.2

(57) ABSTRACT

A bedroll protector for containing, storing and transporting a bedroll. The bedroll protector comprises an elongated substantially rectangular bag body with an openable flap or sheet for receiving a bedroll. The protector may be placed on the ground in an unrolled configuration to receive and insulate a user's bedroll from damp and dirty ground conditions. The protector also comprises at least one vent thereon for selectively allowing airflow in and out of the protector. Upon receiving a bedroll, the bedroll protector may also be rolled up and secured in such position by accompanying straps to allow storage and transportation of the bedroll.

### CROSS REFERENCE TO RELATED APPLICATIONS

The present application claims priority under 35 U.S.C. §119 and is a continuation-in-part of U.S. patent application Ser. No. 11/861,463, filed on Jul. 31, 2007, the disclosure of which is incorporated herein by reference.

### FIELD OF THE DISCLOSURE

The present disclosure generally relates to a sleeping bag casing, and more particularly, to a bedroll protector for storage, insulation, and transportation of a bedroll.

### BACKGROUND OF THE DISCLOSURE

Backpacking, camping, trekking, hiking, backcountry skiing, bike touring, and canoeing are examples of popular outdoor activities. Campers, trekkers, and backpackers seek to minimize the weight and bulk of gear carried by them by using lightweight gear.

For extended stays, the campers, trekkers, and backpackers generally carry a bedroll, such as a sleeping bag, a mattress and a backpack or knapsack filled with personal items such as food items, clothing, medicines and other articles used by them in their expeditions. Typically, any personal item stored in the backpack or knapsack is transported on the individual's back or is hand-carried. The bedroll is also generally rolled up into a bulky cylindrical package and is secured to the exterior of a knapsack, where it remains exposed to the elements.

Stuff bags or stuff sacks may be used by campers, trekkers, and backpackers to store and transport bedrolls. Such bags and sacks have limitations in providing adequate help in terms of compactly storing the bedroll. These stuff bags only serve the purpose of holding the bedrolls and are not of any additional functional help to the user. Additionally, campers, trekkers, and backpackers have to carry a separate mat to be used where they want to camp. This increases the load that the user must carry. A common problem with these mats is that they get easily soiled or damaged from direct contact with the ground and moisture thereon, making sleeping conditions miserable and unpleasant.

Several attempts have been made to provide a protective enclosure for the bedrolls that may be used by campers, trekkers, and backpackers. The protective enclosures of the existing art although provide some protection to the bedrolls but they are mostly limited in their functionality, and are structurally complex and expensive. For example, protective enclosures of the prior art do not serve the simultaneous functions of allowing the user to store and transport a bedroll and to use the enclosure as insulation from damp or uneven ground on which the user chooses to place his or her bedroll.

Therefore, in light of the above, there exists a continuing need in the art for a bedroll protector for storing and transporting a bedroll compactly and with ease. Further, there is a need felt in the art for a bedroll protector which, besides permitting storage and transportation of the bedroll, also serves as an insulating barrier between the user's bedroll and damp, dirty, muddy, or uneven ground. Further, there is a need in the art for a bedroll protector that permits at least some ventilation within and out of the protector, for contributing to the comfort of a user of a protector and for reducing the incidence of unhygienic conditions within the protector.

### SUMMARY OF THE DISCLOSURE

In view of the foregoing disadvantages inherent in the prior art, the general purpose of the present disclosure is to provide a bedroll protector for campers, trekkers, and backpackers to include all the advantages of the prior art, and to overcome the drawbacks inherent therein

In one aspect, the present disclosure provides a bedroll protector for holding and protecting a bedroll. The bedroll protector is an elongated substantially rectangular bag body. The bedroll protector comprises a lower portion configuring a perimeter edge and an upper portion integrally connected to the lower portion at the perimeter edge. The upper portion has a flap openable about the upper portion. The flap is openable in a manner such that the flap upon opening configures a slot for receiving a bedroll therethrough and onto the lower portion.

In another aspect, the present disclosure in an unrolled position provides a portable mat system that insulates a bedroll and a user from damp, dirty, and muddy ground conditions. In one embodiment, the present disclosure insulates the bedroll from exterior conditions, effectively increasing the temperature rating of the bedroll.

In another aspect, the present disclosure provides a compact and waterproof carrier for bedrolls.

### BRIEF DESCRIPTION OF THE DRAWINGS

The advantages and features of the present disclosure will become better understood with reference to the following detailed description and claims taken in conjunction with the accompanying drawings, wherein like elements are identified with like symbols, and in which:

FIG. 1 is a top perspective view of a bedroll protector 100 in an unrolled position, according to an exemplary embodiment of the present disclosure;

FIG. 2 is a bottom perspective view of the bedroll protector 100 in an unrolled position, according to an exemplary embodiment of the present disclosure;

FIG. 3 is a perspective view of the bedroll protector 100 in an unrolled position with a flap lying open on one side, according to an exemplary embodiment of the present disclosure;

FIG. 4 is a perspective view of the bedroll protector 100 in an unrolled position with a flap lying on one side and a bedroll positioned inside therein, according to an exemplary embodiment of the present disclosure; and

FIG. 5 is a perspective view of the bedroll protector 100 in a rolled up position, according to an exemplary embodiment of the present disclosure.

Like reference numerals refer to like parts throughout the description of several views of the drawings.

### DETAILED DESCRIPTION OF THE DISCLOSURE

For a thorough understanding of the present disclosure, reference is to be made to the following detailed description, including the appended claims, in connection with the above-described drawings. Although the present disclosure is described in connection with exemplary embodiments, the present disclosure is not intended to be limited to the specific forms set forth herein. It is understood that various omissions and substitutions of equivalents are contemplated as circumstances may suggest or render expedient, but these are intended to cover the application or implementation without departing from the spirit or scope of the claims of the present disclosure. Also, it is to be understood that the phraseology and terminology used herein is for the purpose of description and should not be regarded as limiting.

The terms “a” and “an” herein do not denote a limitation of quantity, but rather denote the presence of at least one of the referenced item.

The present disclosure provides a novel and economically advantageous solution to longstanding problems faced by trekkers, campers and backpackers by providing means to compactly store bedrolls, sleeping bags, mats and other articles of utility used by them in their expeditions with greater ease and efficiency. Besides being a carryall for storing sleeping bags, mats and the like, the present disclosure also provides an improved portable waterproof mat system for a user.

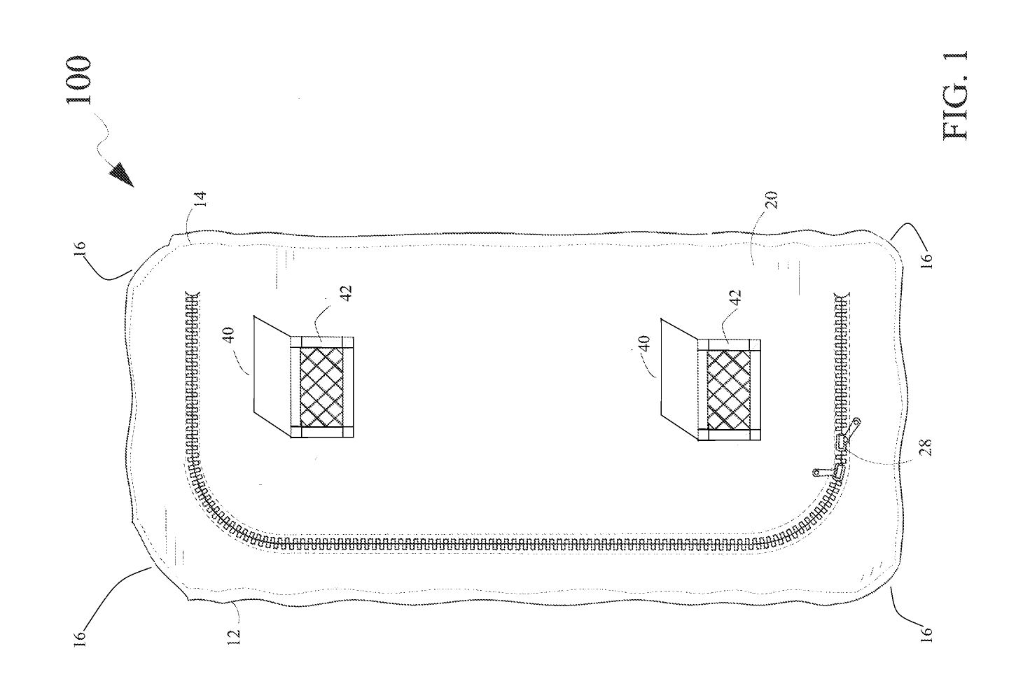

Referring to FIGS. 1-5, a bedroll protector 100 for storing and protecting a bedroll is provided. The bedroll protector 100 comprises an elongated substantially rectangular bag body having a lower portion 10 and an upper portion 20 (See FIGS. 1 & 2). The lower portion 10 configures a perimeter edge 12 and the upper portion 20 is integrally connected to the lower portion 10 at a seam 14 along the perimeter edge 12 (See FIG. 1). The lower portion 10 and the upper portion 20 are substantially of the same size. The integral connection of the upper portion 20 and the lower portion 10 along the perimeter edge 12 configures a hollow space therebetween.

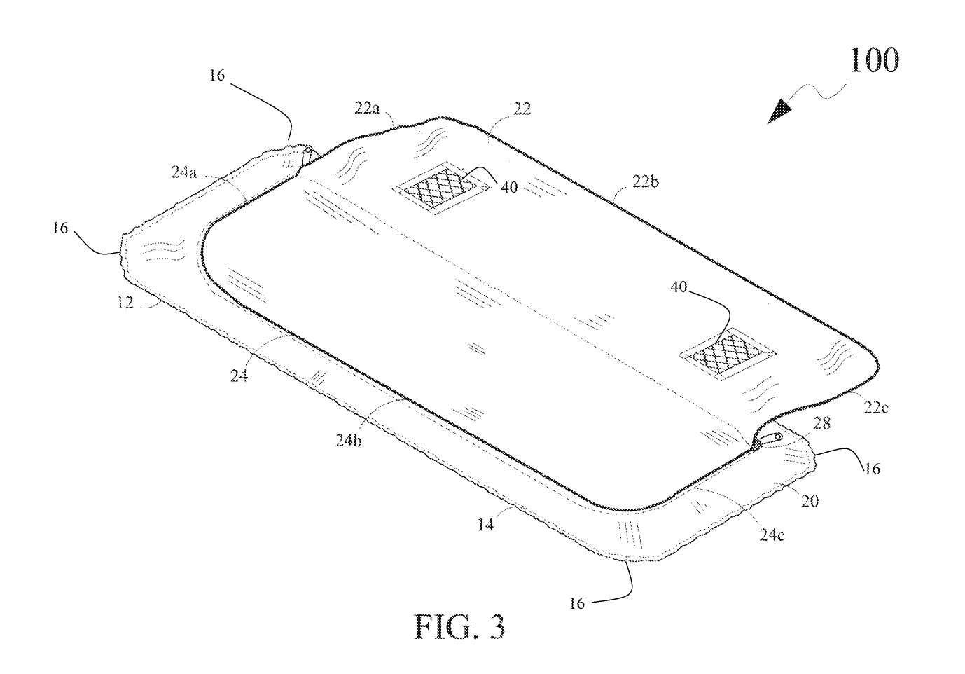

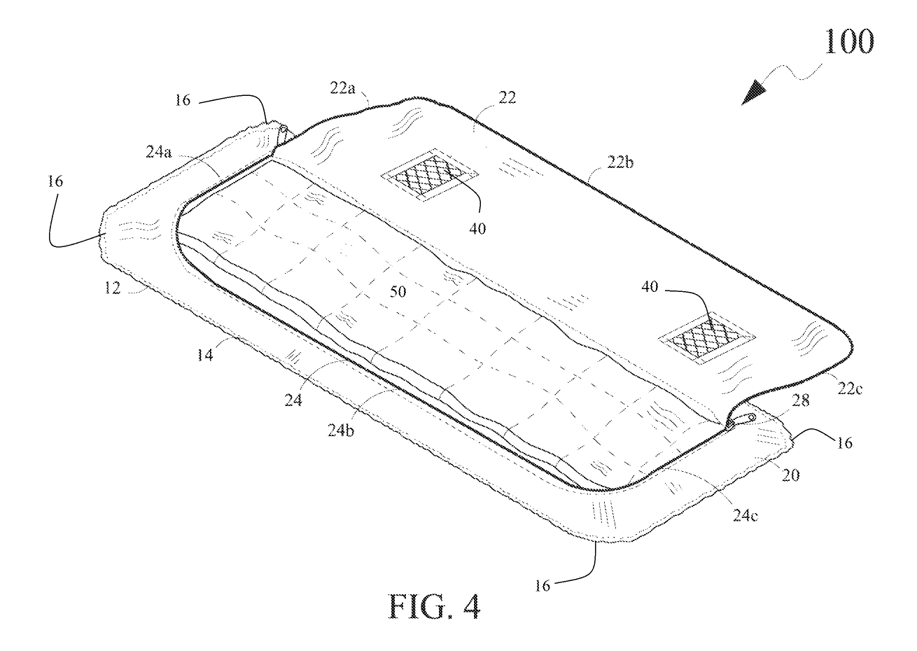

The upper portion 20 has a cover 22 (See FIG. 3) openable about the upper portion 20. The cover 22 is a non-detachable three side openable cover configured on the upper portion 20. The cover 22 has engagement features disposed on all three sides 22a, 22b and 22c of the cover 22. The cover 22 is configured in a manner such that the cover 22 upon opening configures a slot 24 in the upper portion 20. Three sides 24a, 24b and 24c of the slot 24 have complementary engagement features capable of removably engaging with engagement features on three sides 22a, 22b and 22c of the cover 22. In one embodiment, the engagement features and the complementary engagement features configure a zipper arrangement 28 for attaching the cover 22 with the upper portion 20. The slot 24 is configured to receive a bedroll 50 therethrough and onto the lower portion 10 (See FIG. 4). The bedroll 50 as used herein may be any sleeping gear, such as a sleeping bag, quilt, blanket and the like.

Referring now to FIG. 1, the upper portion 20 further comprises at least one vent 40, which at least one vent 40 is capable of opening and closing, and which vent 40 allows air to flow through a section of the upper portion 20 when such a vent 40 is in an open position. The at least one vent 40 comprises a subsection of the upper portion 20, which subsection includes a coverable region of permeable material, which region is covered by a flap 42 of impermeable material. In an embodiment, the permeable material comprises a mesh fabric, and the impermeable material comprises the material from which the protector 100 is made from, i.e., a durable, waterproof and non-breathable material described below.

The flap 42 comprises a non-detachable three side openable cover configured on the upper portion 20, which flap 42, when opened, exposes the permeable material of the least one vent 40, such that air from the interior of the protector 100 may exit through the permeable material to the atmosphere, and atmosphere may enter into the interior of the protector through the permeable material. When the flap 42 of the vent is closed, it will be apparent that no air or atmosphere may pass through the vent 40 out of or into the interior of the protector 100. It will further be apparent that a user of the protector 100 may selectively open the vent 40 in dry and/or warmer conditions to allow airflow into the protector 100 for cooling the interior of the protector 100 and the user therein, and for exhausting sweat and other emissions from the interior of the protector, thus increasing the comfort of a user that is situated within the protector 100.

The non-detachable portion of the vent 40 is securely and substantially permanently attached to the three-side openable cover, by way of a heat seal or stitched seam, for example. The non-detachable portion allows the flap 42 to remain attached to the bedroll protector 100 when the vent 40 is open (i.e., when the flap 42 is disposed such that the permeable material is exposed.) The vent 40 further comprises engagement features on the openable three sides, and the upper portion 20 of the bedroll protector 100 comprise complementary engagement features, such that the engagement features may hold the flap 42 of the vent 40 in place when the user prefers to close the vent 40. In an embodiment, the complementary engagement features of the vent 40 and upper portion 20 comprise a hook and loop arrangement (such as Velcro®). In another embodiment, the complementary engagement features comprise a zipper arrangement.

The at least one vent 40 is, in an embodiment, disposed in proximity to one of the shorter sides of the protector 100, and in a further embodiment, approximately 12 inches from said side, with the vent 40 being centrally disposed between the sides that are perpendicular to said short side. In another embodiment, two vents 40 may be disposed at opposite ends of the protector (as shown in FIGS. 1, 3, and 4), with each vent being disposed in proximity to a shorter side of the protector in the exemplary configuration described above.

Preferably, the bedroll protector 100 is made from a durable, waterproof and non-breathable material. The material is flexible and non-susceptible to extreme temperature conditions. In one embodiment of the present disclosure, the waterproof non-breathable material is flexible polyethylene with a fineness of 1,000 deniers and being capable of withstanding temperature as low as −70° F. Due to the integral connection between the lower portion 10 and the upper portion 20, the bedroll protector 100 configures a double polylaminated construction. The bedroll protector 100 may be configured in variety of shapes and sizes to suit the preference of multitude of people. In one embodiment of the present disclosure, the bedroll protector 100 is substantially rectangular in shape having a length of 96 inches, a folded breadth of 36 inches and an unfolded breadth of 72 inches. In place of the four corners of a rectangle is a transition segment 16, which transition segment 16 connects each side of the rectangular shape at a 45 degree angle between each side. In a preferred embodiment, the transition segment 16 is three inches in length.

Along the perimeter edge 12, the lower portion 10 is securely attached to the upper portion 20 at the seam 14 by means of stitching or other suitable connection means known in the art. In one embodiment of the present disclosure, the lower portion 10 and upper portion 20 are electronically heat-sealed at the seam 14 to make the bedroll protector 100 completely waterproof.

The zipper arrangement 28 may be a heavy duty two pull nylon zipper backed with an adhesive tape to prevent the entry of water or moisture. In one embodiment of the present disclosure the zipper arrangement 28 is a waterproof ziplock zipper. The zipper arrangement 28 may also comprise an overlapping layer of fabric to cover the zipper for further protecting the zipper and interior of the protector from elements and for reducing the entry of unwanted materials from outside into the interior of the protector.

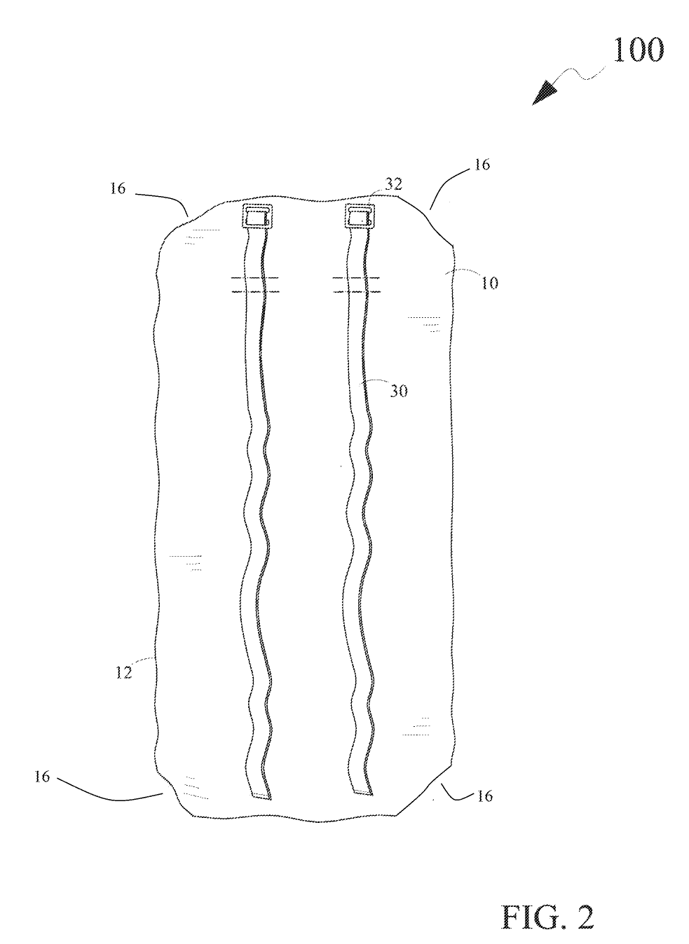

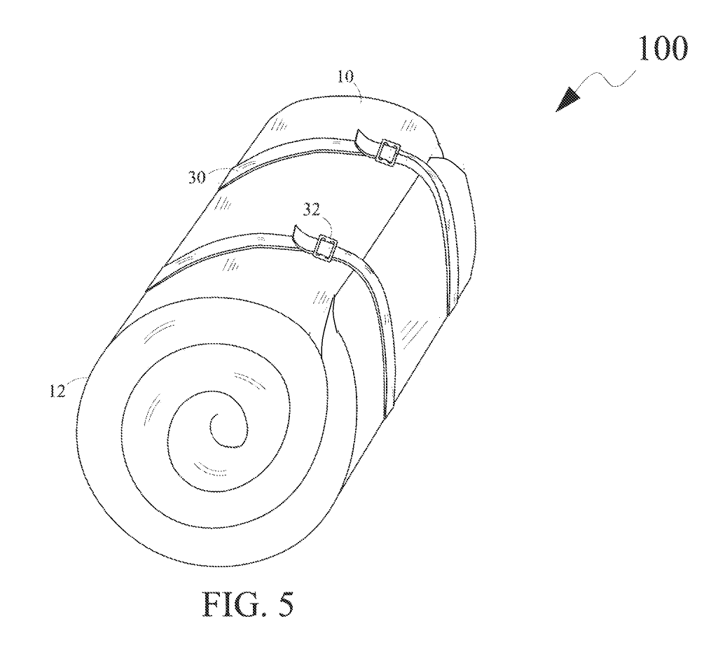

The bedroll protector 100 may be further provided with a strap arrangement comprising a strap 30 and a connector 32 to secure the bedroll protector 100 in a rolled up position (See FIGS. 2 and 5). The strap 30 may be made from any material providing sufficient strength to hold the bedroll protector 100 in the rolled position, for example, nylon webbing, polypropylene and other sturdy materials. In one embodiment of the present disclosure, the strap 30 is a compression strap to compress the size of the bedroll protector 100 in the rolled position. The connector 32 may be a snap-in connector, ladder lock, buckle, or any other suitable connector known in the art. The strap arrangement may be a entity separate from the bedroll protector 100 or may be attached to the bedroll protector 100 at the lower surface 10. In the rolled position, the transition segments 16 at each corner of the protector facilitate compact compression of the bedroll protector 100, as there are no sharp (i.e., 90 degree) corners of the protector to flare outwardly when the protector is in a rolled position.

Additionally, the bedroll protector 100 may be provided with suffocation warning labels adhered at least on one side of the upper portion 20.

In use, the bedroll protector 100 is laid down on a ground surface in a manner so that the lower portion 10 rests on the ground. The zipper arrangement 28, connecting the three sides 22a, 22b and 22c of the cover 22 with the adjoining three sides 24a, 24b and 24c of the slot 24, is opened. Once the zipper arrangement 28 is completely opened, the cover 22 folds over to the side of the upper portion 20. A bedroll 50 is inserted through the slot 24 into the hollow space between the lower portion 10 and the upper portion 20 and spread out through out the length and breadth in the hollow space therebetween. Thereafter, the three sides 22a, 22b and 22c of the cover 22 may once again be disposed over the three sides 24a, 24b and 24c of the slot 24 and removably engaged thereto using the zipper arrangement 28. The bedroll protector 100 may then be rolled into a carrying configuration as shown in FIG. 5. The bedroll protector 100 is secured in a rolled position by the strap arrangement. The transition segments facilitate in creating a compact compression of the bedroll protector 100. The strap 30 is wound around the rolled up bedroll protector 100 and removably coupled with the connector 32. The strap arrangement may be adjusted as necessary to tighten or loosen the bedroll protector 100. The bedroll protector 100 in a rolled position forms a cylindrical configuration and may be easily transported or carried by a user. The bedroll protector 100 may be strapped to a backpack, motorcycle, horseback, ATV, tossed in a canoe, the back of a truck, a car trunk and the like.

In addition, the bedroll protector 100 may be used as a mat in an unrolled position. When unrolled and laid on a ground, the zipper arrangement 28 is opened and the cover 22 is folded to one side. The bedroll protector 100 provides a waterproof barrier between the ground and the bedroll 50. Furthermore, the slot 24 configures a bath-tub feature, as the sides of the slot 24 remains in an elevated position, thereby preventing water from entering from the sides of the bedroll protector 100. The configuration of the bedroll protector 100 is such that to prevent the bedroll 50 from slipping off or out of the bedroll protector 100. The cover 22 may be used to hold various items, for example, books, food material, clothes and others, as the cover 22 is also waterproof. The at least one vent 40 may be selectively opened during use to increase airflow and comfort for a user of the bedroll, and may be closed when conditions so require.

From the foregoing, it may be seen that the bedroll protector 100 affords several advantages including but not limited to compact storage of bedrolls, reduced size when rolled for transportation and storage, and reduced likelihood of damage to the bedroll either from water or snags or tearing, and usage as a mat when in unrolled position. The bedroll protector 100 may also be used for transportation of game animals and game fish, storage of household items like clothes, outdoor furniture, cushions, books and the like.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omission and substitutions of equivalents are contemplated as circumstance may suggest or render expedient, but such omission and substitutions are intended to cover the application or implementation without departing from the spirit or scope of the claims of the present disclosure.

What is claimed is:

1. A bedroll protector, comprising:
an elongated substantially rectangular bag body comprising
a lower portion configuring a perimeter edge,
an upper portion integrally connected to the lower portion at the perimeter edge, the upper portion having a flap openable about the upper portion, in a manner such that the flap upon opening configures a slot for receiving a bedroll therethrough and onto the lower portion,
a transition segment at each corner of the rectangular body, said transition segment joining two sides of the rectangular body, and
at least one openable vent disposed on said upper portion.

2. The bedroll protector of claim 1, wherein the flap is openable about the upper portion using a zipper arrangement.

3. The bedroll protector of claim 1, wherein the upper portion and the lower portion are integrally connected at a seam along the perimeter edge using at least one of stitching and electronic heat sealing.

4. The bedroll protector of claim 1, wherein the bedroll protector configures a double polylaminated construction.

5. The bedroll protector of claim 1, wherein the bedroll protector is made up of polyethylene.

6. The bedroll protector of claim 1, further comprising a strap arrangement for securing the bedroll within the bedroll protector in a rolled up position.

7. The bedroll protector of claim 1, wherein the at least one vent comprises a subsection of the upper portion of the bedroll protector and a flap,
wherein said subsection of said upper portion comprises a permeable material,
wherein said flap is configured to removably cover said subsection of permeable material, and
wherein said vent and said upper portion comprise complementary engagement features for removably closing said flap over said subsection of permeable material.
